(19) United States
(12) Patent Application Publication
(10) Pub. No.: US 2008/0298237 A1
(43) Pub. Date: Dec. 4, 2008

(54) Methods, Systems, and Apparatus of Providing QoS and Scalability in the Deployment of Real-Time Traffic Services in Packet-based Networks

(75) Inventors: Rene Maria B. Dos Remedios, Muntinlupa (PH); Joel C. Delos Angeles, Paranaque (PH); Roy A. Orpiano, Marikina (PH)

Correspondence Address: RENE MARIA B. DOS REMEDIOS, BLDG. 7, LOT 52, FTI COMPLEX, TAGUIG, NCR, 1630, PH

(73) Assignee: Latitude Broadband, Inc.

(21) Appl. No.: 11/462,044

(22) Filed: Aug. 3, 2006

(51) Int. Cl. G01R 31/08

(52) U.S. Cl. 370/233

(57) ABSTRACT

Methods, Systems, and Apparatus of Providing QoS and Scalability in the Deployment of Real-Time Traffic Services in Packet-based Networks are disclosed. The aim of the invention is to provide QoS for both realtime and non-real-time traffic streams.

The invention presents an architectural framework coupled with the functional apparatus necessary to deploy services like Voice over IP (VOIP) in a scalable way in spite of network limitations such as shortage in IPV4 addresses, NAT traversal, and the processor-intensive requirements of RTP termination. Methods to solve these problems associated with large-scale VoIP deployment by distributing application gateways are presented. More importantly, the approach serves to provide consistent broadband performance over access technologies which are prone to capacity degradation due to unregulated admission of real-time traffic streams like VoIP and IP Television.

The paper gives emphasis on broadband wireless because of its shared access mechanism.

### BACKGROUND OF THE INVENTION

Network and service providers are looking at offering Triple Play services to their existing customers to generate additional revenue. Triple Play services refer to three key services: high-speed Internet, telephony services, and television services (Video on Demand or regular broadcasts or IPTV) over a single broadband connection.

VoIP and IPTV protocols work well in wire-line last-mile access because of the availability of large amount of unshared bandwidth. The emergence of broadband wireless access (BWA) presents an opportunity to deploy ubiquitous IP services. However, the shared access mechanisms in such technology present its own problems. One such limitation is the capacity inefficiency associated with running small packet streams over BWA. VoIP protocols use small packet streams as payloads in media protocols such as Real-Time Transport Protocol (RTP) packet streams. Unregulated admission of RTP packet streams reduces the bandwidth allocation for regular internet traffic which also leads to degradation of the quality of the voice and video services in a shared access medium like wireless broadband. Moreover, instead of only denying the last call which will violate the capacity threshold, the lack of call admission will degrade all ongoing voice calls.

In addition to the above challenges, real-time traffic service protocols usually require termination clients with public IP addresses, whereas IPV4 addresses is already in shortage. The typical solution is to Network Address Port Translation (NAPT) or NAT. Real-time traffic streams such as those running over the Session Initiation Protocol (SIP) are not inherently designed for NAT traversal. The SIP protocol is only the signaling protocol. The actual media payload rides on top of RTP. SIP allows all participating parties to find each other on the network, to negotiate the media transfer protocol(s) and protocol parameters, to establish interactive real-time sessions, and to manage those sessions. The media transfer protocol or RTP parameters consists of the IP addresses, the UDP ports and the CODEC to be used during the voice session. The SIP client is not aware that it is behind a NAT device and will use the private IP assigned to it in the SIP request. Because private IP are non-routable in the internet the RTP packet will not reach its destination.

Existing solutions are proposed created to solve the NAT traversal problem such as STUN. However, the former needs a server on the WAN and a client application installed in the client device. In addition, it is not part of the SIP standard protocol. More so, STUN only works on three of four main types: full cone NAT, restricted cone NAT, and port restricted cone NAT. It will not work with symmetric NAT (also known as bidirectional NAT). Session Border Controllers (SBC's) are also deployed to handle NAT traversal on the signaling and the media protocols. The use of centralized RTP termination in these boxes presents a scaling problem. Instead of taking advantage of the peer-to-peer nature of media traffic between terminals, SBC's centralize and aggregate media traffic, thus leading to non-optimized usage of link paths. RTP media termination requires intensive processing—an order of magnitude more demanding than SIP signaling termination.

This invention proposes a scalable way of addressing the main problems of deploying real-time traffic service such as VoIP: 1) Shortage of IPV4 addresses 2) NAT Traversal 3) Call admission and QoS and 4) media (RTP) termination. The solution is a distributed architecture of Access Controllers functioning as NAT gateways, call admission control enforcers, and SIP and RTP termination points. By deploying Access Controllers with Network Address Translation or NAT capability, network providers conserve the limited resource of public IP addresses. The distribution of Access Controllers is also an opportunity to distribute voice termination and call admission.

Similar to the RNC and BSC of cellular technologies, the Access Controller can be deployed in the base stations or at other points in the network to implement critical functions such as access functions and enforcement of resource and admission control and network attachment control functions. The functions of the Access Controller are also detailed in the patent application by Dos Remedios et. al., “Methods and Systems for Call Admission Control and Providing Quality of Service in Broadband Wireless Access Packet Based Networks.” The terms Access Controller and Base Station Controller is used interchangeably in this paper.

### BRIEF SUMMARY OF THE INVENTION

Large-scale deployment of real-time traffic services has several challenges namely; 1) Shortage of IPV4 addresses 2) NAT Traversal 3) Call admission and QoS and 4) Media (RTP) termination. Although several solutions have been proposed such as the use of NAT together with Session Border Controllers (SBC) application, a scalable architectural framework has not been addressed. This invention presents the architectural framework and the apparatus to make scalable VoIP deployment a reality. The invention applies not only to SIP VoIP but also in real-time traffic streams in general. For the sake of simplicity, discussions and illustrations use SIP terminologies. Similarly, broadband wireless access is used for the discussion of the last-mile access functions, although the invention includes implementation in other types of access such as DSL and cable.

This paper proposes a distributed architecture using Access Controllers at points in the network such as base stations in broadband wireless access to implement NGN functions such as transport and access functions (prioritization, traffic shaping, QoS), network attachment (management of subscriber IP addresses and announcement of service contact point), enforcement of resource and admission control (call admission), and media gateway functions (SIP and RTP termination). The Access Controller also interacts with the Service functions such as the service control in the SIP softswitches to implement a smooth end-to-end call admission control between the calling and the called party.

The Access Controller implements NAPT, QoS, and VoIP application gateway/proxy server functions. Implementing an application gateway for real-time traffic services in the Access Controller to handle signaling and media requests solves the NAT traversal issue at the NAT box. The Access Controller also integrates the call admission control with access functions such as bandwidth management. Both critical functions are geared towards a total Quality of Service (QoS) solution for the mission-critical real-time applications and also for applications requiring best effort service.

An Application Proxy Server or Application Gateway is used in this paper as a general term for real-time application proxy servers, such as an Outbound Proxy in SIP for VoIP or IPTV proxy servers. The Application proxy server may also redirect SIP traffic transparently in order to implement call admission on hosted or non-hosted VoIP traffic. Hosted is used in this paper to describe cases where the user knowingly sets the Access Controller as the SIP proxy server, while non-hosted generally describes cases wherein the user SIP termination is beyond the Access Controller to the Internet. In either case, the Access Controller terminates the sessions, explicitly for hosted or transparently for non-hosted, and communicates with the other end of the voice session and to the SIP signaling softswitch. The Application Proxy Server is a software application inside the Access Controller, communicating real-time traffic to different endpoints on behalf of the client.

The admission control mechanism of the present invention uses the User Profile information on each Base Station Controller. The data contained in a User Profile includes, the Network Attachment Information of the subscriber. This information may include vital parameters such as the IP and MAC address of the subscriber terminal equipment or the radio sector where it is homed to.

A weight is assigned for each of the CODEC to represent the equivalent capacity usage. The sum of these weight values per ongoing call becomes the basis for setting and enforcing call admission threshold. A method on how to characterize a wireless access to get the limit for the number of simultaneous small packet streams per radio sector is discussed in a patent pending paper by Dos Remedios et. al, “Methods and Systems for Call Admission Control and Provisioning Quality of Service in Broadband Wireless Access Packet-Based Networks”.

### BRIEF DESCRIPTION OF THE SEVERAL VIEWS OF THE DRAWINGS

FIG. 1 is a typical network implementation of a wireless broadband internet deployment.

FIG. 2 shows a block diagram of the Access Controller with Application Proxy Server and Admission Control.

FIG. 3 is a sample Admission Control table which tracks the number of simultaneous real-time sessions on each radio sector.

FIG. 4 is a sample Call and Transaction State table.

FIG. 5 is sample table of the weight assignment for each CODEC.

FIG. 6 is sample user profile.

### DETAILED DESCRIPTION OF THE INVENTION

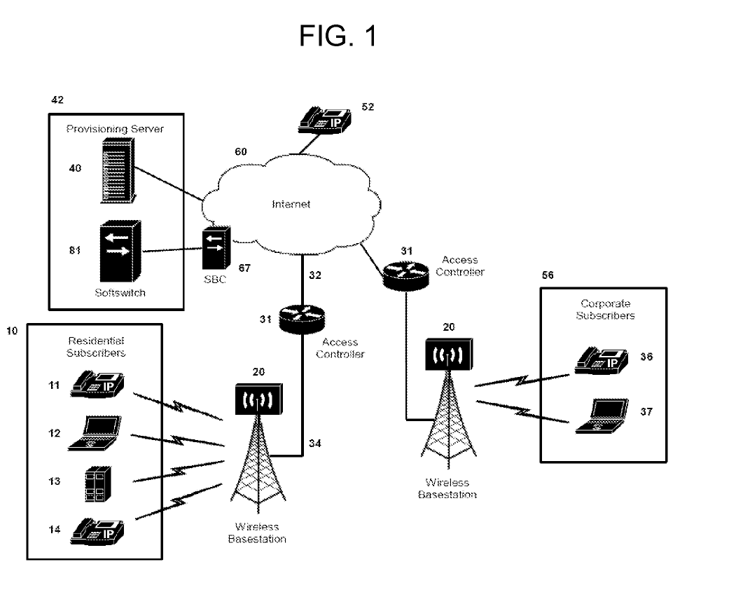

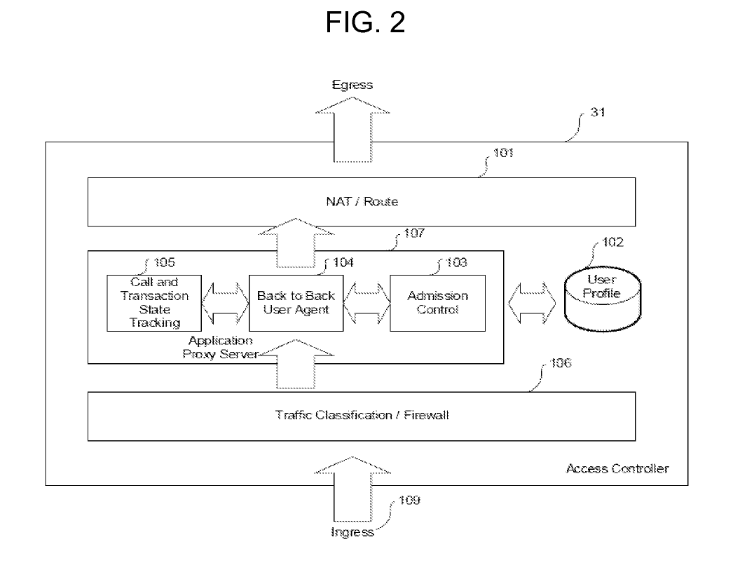

The discussion that follows describes the present invention. The prevailing context is that of SIP VoIP in Broadband Wireless Access 20 (BWA) although this does not limit the applicability of the invention to other real-time traffic stream applications, and other access technologies such as DSL and cable. Whenever applicable, NGN functional terms are used. FIG. 1 shows a sample network architecture for a Broadband Wireless Access network.

Real-time traffic stream protocols usually require visible and routable IP addresses to terminate the sessions. Thus, a large-scale deployment of services such as VoIP will require a large number of public IP addresses, the IPV4 version of which is already in shortage. The straightforward solution is to implement Network Address Port Translation (NAPT/NAT) in some nodes or routers within the network provider IP cloud. This paper implements this IP management function, a subset of NGN Network Attachment Control Functions (NACF), in network nodes known as Access Controllers 31. The Access Controller 31 can also implement NACF announcement of service contact point such as advertising itself or another entity as the SIP proxy using a hosted TFTP configuration file in DHCPv4 or SIP Proxy IP in DHCPv6. An Access Controller 31 is the Broadband Wireless Access 20 (BWA) equivalent of cellular system's Base Station Controller or Radio Network Controller (BSC/RNC). Public IP addresses are assigned only to clients whose applications require them such as corporate clients 56. Private IP addresses, which can be re-used per base station, are assigned to residential subscribers 10 which is compose the bulk of VoIP service customers.

NAT solves the IP shortage problem while introducing a new one. VoIP signaling protocols often carry the original IP address of the terminal end points. In the proposed NAT-based solution, these IP addresses may be private and non-routable, necessitating a way to circumvent the NAT traversal problem. Deploying Session Border Controllers 67, which is the usual solution at the time of writing, has scalability problems of its own. Terminating RTP media streams into SBCs 67 require either a distributed system to scale, or a fast-processing, not to mention expensive, centralized node. Instead of introducing huge Session Border Controllers 67 (SBC's) into the network to solve a fairly simple problem, this invention works on the paradigm of “solving the NAT traversal problem at the NAT box.” An Application Proxy Server 107 or Application Gateway software module is integrated with the Access Controller 31. The software module handles both SIP signaling and media transfer on behalf of the subscriber terminals which passed through the NAT process 101.

The three main components of the Application Proxy Server 107 are the Call and Transaction State Tracking 105, Back-to-Back User Agent 104 and the Call Admission Control 103. Connection requests and call session status monitoring is performed in the Call and Transaction State Tracking 105 module. On the other hand, the Back-to-Back User Agent 104 handles signaling and media transfers. While the Call Admission Control 103 module ensures Quality of Service by limiting the number of media streams on each wireless access sector.

The distributed Access Controller 31 architecture also solves the scaling problem associated with terminating VoIP sessions, especially the media RTP stream. Localizing the proxy server 107 at the base stations optimizes the performance of the VoIP network by load-balancing the RTP media termination among the base station Access Controllers 31. Thus, cost-effective Access Controllers 31 can be sized to handle predetermined maximum number of simultaneous voice calls. The peer-to-peer nature of media traffic between terminals is also put to use by distributing media termination points throughout the network, optimizing the utilization of different link paths.

The Access Controller 31 is a QoS device designed to implement Resource and Admission Control (RAC) policies. Bandwidth management and traffic-shaping would not suffice in guaranteeing QoS for the ongoing calls. This is especially evident in the shared mechanism of BWA 20 technologies. Admission control must also be implemented. Instead of degrading all ongoing calls, the last call to exceed a set threshold will be denied. For issues again of scalability, the Call Admission Control 103 (CAC) mechanism of the present invention is employed in a distributed manner using multiple Access Controllers 31. The Application Proxy Server 107 module resides in each Access Controller 31.

FIG. 8 is a SIP call flow used to illustrate how the Call Admission Control 103 (CAC) mechanism can be implemented, although Application Proxy Server 107 modules can also be installed for other protocols like H.323 or IPTV. To establish an interactive real-time sessions or a call-session in SIP the calling party sends an Invite request 801 to a SIP or SIP proxy server, usually a termed as a softswitch 81. The server 81 routes the request 801 to the intended recipient of the Invite request or to another softswitch 81 serving the called party. Part of the request payload is a list of the preferred voice compressions or the CODECs and the port to be used for the media session (Real-time Transport Protocol or RTP). The called party sends an OK message 804 with the agreed CODEC and port and the calling party acknowledges the message in return. Then the call-session or the RTP voice media exchange follows.

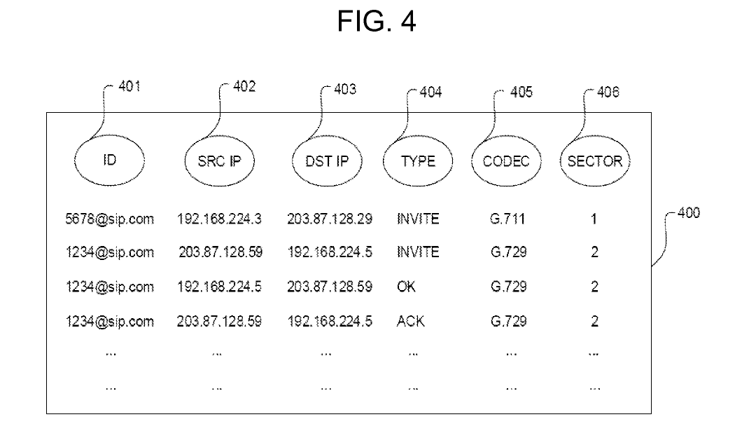

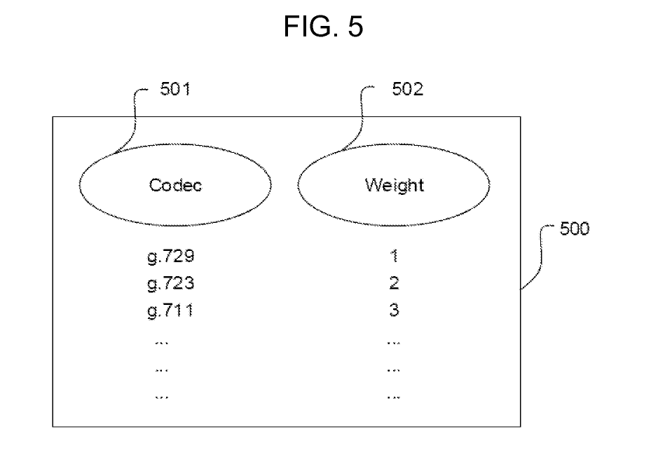

Using the above SIP call establishment flow, the session initiation request 801 goes through the Application Proxy Server 107. The request is stored in the Application Proxy Server's 107 Call and Transaction State Tracking 105 system. FIG. 4 shows a sample state table of the call requests. Before the Server 107 allows the call to go through the server does the following:

1. The CODEC to be used for the media transfer is assigned a weight; the weight is extracted from the CODEC weight assignment table 500 generated by the wireless access 20 characterization process, as defined in the patent application by Remedios, et. al., “Methods and Systems for Call Admission Control and Provisioning Quality of Service in Broadband Wireless Access Packet-Based Networks”

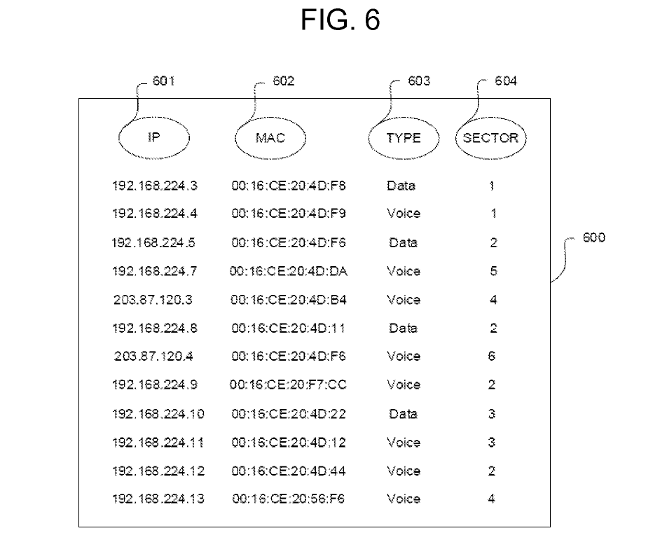

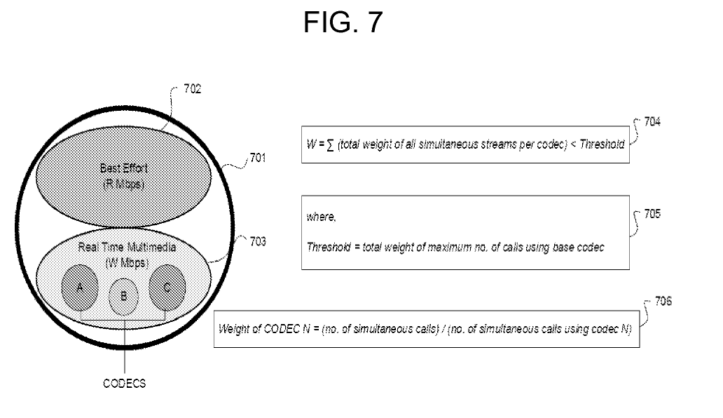

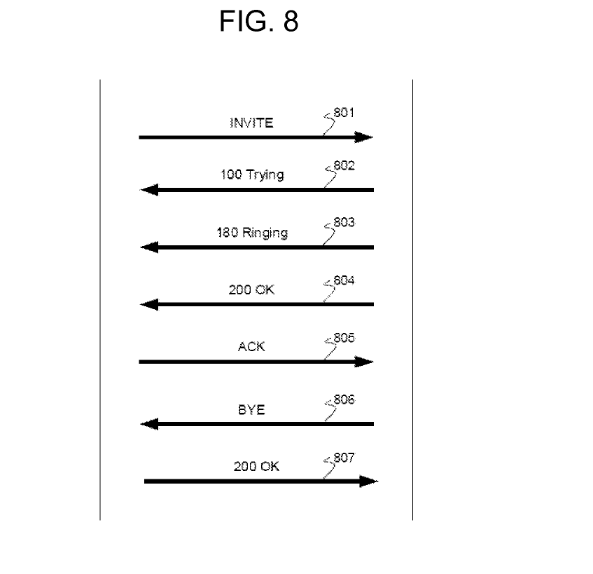

2. The server queries a User Profile 102 Database table, shown in FIG. 6, to get the Network Attachment information of the subscriber which includes the IP 601 and MAC 602 address of the terminal, the CODEC weight 502, and the serving sector 604. These parameters are input to the Call Admission Control 103 (CAC) function of the Application Proxy Server 107. For faster response time, the user profile 102 and codec weight tables 500 can be stored inside the Access Controller 31.

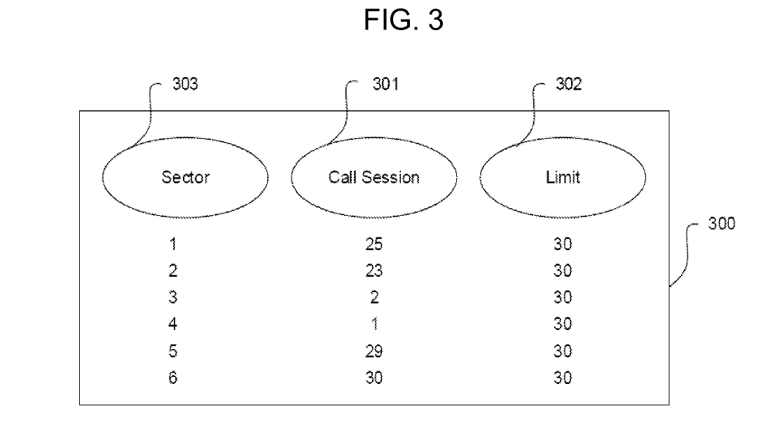

3. The Call Admission Control 103 checks if the sum of the CODEC weights of the ongoing calls per sector 704 together with that of the incoming call or media will exceed a set threshold 705 value. FIG. 3 shows a sample session table.

4. If the sum 704 exceeds the limit 705, the request is rejected. This is handled by the Application Proxy 107 as a call rejection message to the parties or terminals involved.

5. Otherwise, the request is allowed to continue; the call goes through and the session counter is increased by the weight of the CODEC 706.

6. When the call terminates the session counter is decreased by the weight of the CODEC 706 used. The Call and Transaction State Tracking 105 function is critical to implement ongoing calls monitoring.

The details of the weight assignment per CODEC and the prerequisite characterization is detailed in the wireless access characterization scheme described in a patent pending approval entitled, “Methods and Systems for Call Admission Control and Provisioning Quality of Service in Broadband Wireless Access Packet-Based Networks”. Allocated bandwidth is budgeted for best-effort 702 services like web browsing and e-mail. The remaining bandwidth in a sector is then allocated for the real-time media 703 traffic. The output of the characterization process is the base or the recommended CODEC like G.729, and the maximum allowable media streams using only the recommended CODEC. The base CODEC is the one which yields the highest number of simultaneous real-time sessions (RTP) while maintaining the quality of the streams and the budget set for regular best-effort traffic. The CODEC of choice is assigned a weight of 1. The weight of any other CODEC 706 is determined by dividing the number of possible simultaneous sessions using the base CODEC by the maximum simultaneous sessions if the other CODEC is used. This is expressed in the equations in FIG. 7.

Non-hosted real-time applications can also be transparently redirected to to the Application Proxy Server 107 or Admission Control 103. Hosted subscribers are “aware” that the calls or media terminate on the Application Proxy 107. This is implemented by explicit configuration of the Access Controller 31 IP address into the subscriber terminal, such as an IP phone 36. Non-hosted applications are supposed to terminate to a softswitch 81 or SBC beyond the Access Controller 31 into the Internet 60. While the Application Proxy Server 107 modifies SIP payload information, such as the VIA header, to communicate on behalf of the hosted subscriber, it does not for non-hosted ones. All media flows, whether hosted or not, may go through the call admission 103 and call tracking 105 processes to guarantee QoS. Different tiers of services can also be implemented by having separate limits for the hosted and the non-hosted real-time sessions. Packet prioritization and bandwidth allocation can also be implemented. For instance, the hosted media flows can take precedence over best-effort traffic and non-hosted media. Non-hosted media flows can be given an equal or even lower priority than best effort data service. The Access Controllers 31 can have different levels of prioritization and bandwidth allocation based on an array of parameters such as subscriber MAC 602 and IP 601 address, types of applications 603, ports, or combinations thereof.

The present invention has been described with reference to specific embodiments mentioned above. However, those skilled in the art will recognize that the invention can be executed with variations and modifications. It is, therefore, intended that the appended claims below shall not be limited to the embodiment introduced above.

What we now claim are as follows:

1) A distributed architecture or system consisting of Access Controllers to enforce key NGN functions which include:
(a) Network Attachment Functions, such as IP address management using NAPT/NAT and announcement of service contact point via a hosted TFTP configuration file in DHCPv4 or SIP Proxy Server in DHCPv6;
(b) Resource and Admission Control Functions such as bandwidth management/allocation and traffic classification/prioritization based on subscriber parameters such as IP and MAC address, type of service, or combinations thereof;
(c) Service Control Functions extensions (SCF) such as Call Admission Control (CAC)
(d) Access transport functions such as traffic classification, prioritization, shaping and bandwidth management;

2) A distributed architecture of system consisting of Access Controllers which solve key problems in scaling the deployment of real-time traffic services, consisting of:
(a) Using private IP addresses for the subscribers and implementing NAT/NAPT in Access Controller entities inside the network provider IP cloud to address the IPv4 address shortage;
(b) Addressing NAT traversal by terminating signaling and media traffic in each Access Controller;
(c) Load-balancing the network media traffic among the Access Controllers to de-centralize the termination of media traffic and to take advantage of IP peer-to-peer traffic efficiency;
(d) Enforcing a method of call admission control in the Access Controllers to guarantee QoS for ongoing calls and also for other types of data traffic;
(e) Incorporating an Application Proxy Server of Gateway as a software module inside the Access Controllers;

3) An Application Proxy Server in claim 1 consisting of:
(a) a software module or computer program running inside the Access Controllers;
(b) A back-to-back user agent (B2BUA) to terminate the signaling and media protocols, which includes generation of allow or rejection messages for call admission control
(c) A call admission control mechanism to interfaces with the B2BUA for allowing or denying calls

4) A system for implementing multiple application proxy servers as defined in claim 3 per type of application and associated protocols like SIP, H.323, or video IPTV

5) A codec weighting method for policing calls or media streams and admission control as set forth in claim 3, consisting of:
(a) Allocating best-effort and media bandwidth based on characterization of the access technology
(b) Setting a base codec as the one which generates the most number of simultaneous media streams while not violating the bandwidth allocation for the best-effort data service
(c) Assigning weights on different codecs or applications with respect to a base codec

6) A Call Admission Control system set forth in claim 2, which is comprised of:
(a) Checking of User Profile tables for network attachment information and user service type (e.g. sector location, IP address, VoIP service)
(b) Correlating these information to track the per sector media traffic usage
(c) Tracking and aggregating the weighted value of each ongoing session
(d) Comparing it to the threshold settings for allowable simultaneous media streams per sector or a portion of the access capacity
(e) Interfacing with the B2BUA to enforce call admission by allowing or denying incoming calls or sessions
(f) Supporting Access Controller-hosted and transparent non-hosted subscriber media service applications

7) A method for differentiating tiers of service to subscribers as part of the Access Controller access transport functions as set forth in claim 1, consisting of:
(a) traffic classification, prioritization, and bandwidth management based on an array of subscriber parameters such as IP and MAC address, type of service, ports or combinations thereof.
